(19) United States
(12) Patent Application Publication
(10) Pub. No.: US 2026/0228936 A1
(43) Pub. Date: Aug. 6, 2026

(54) Method for Generating Synthetic Images

(71) Applicants: ROBERT BOSCH GmbH, Stuttgart (DE); CARIAD SE, Wolfsburg (DE)

(72) Inventor: Alexander Kugele, Kornwestheim (DE)

(21) Appl. No.: 19/458,624

(22) Filed: Jan. 23, 2026

(30) Foreign Application Priority Data
Jan. 21, 2025 (DE) 10 2025 103734.5

(51) Int. Cl. G06T 11/00; G06T 5/60; G06T 5/70; G06V 10/764; G06V 10/774; G06V 10/776

(52) U.S. Cl. CPC G06T 11/00; G06T 5/60; G06T 5/70; G06T 2207/20081; G06T 2207/20084; G06T 2207/30252; G06V 10/764; G06V 10/774; G06V 10/776

(57) ABSTRACT

The invention relates to a Method for generating synthetic images by means of a generative model, in particular a diffusion model, comprising the following steps:
Providing an input,
Processing the provided input in a first iterative process, at least by a noise remover, wherein in a first noise regulation process, noise in an intermediate generated image is repeatedly reduced and added,
Processing an intermediate output of the first iterative process in a second iterative process, at least by the and/or a further noise remover, wherein in a second noise regulation process noise is repeatedly reduced and added in multiple intermediate generated images,
Providing an output of the second iterative process.

### FIELD OF THE INVENTION

The invention relates to a method for generating synthetic images. The invention also relates to a computer program, an apparatus, and a storage medium for this purpose.

### BACKGROUND

Neural networks are currently the preferred method for processing image data in many areas. The quality of the networks depends on the data used to train the network.

However, compiling training data is becoming increasingly challenging. Generative neural networks are therefore often used, which may generate images based on text input or similar. Since a certain amount of data is usually required, the efficient generation of such data is crucial.

### SUMMARY

Subject matter of the invention is a method with the features of claim 1, a computer program with the features of claim 8, an apparatus with the features of claim 9, and a computer-readable storage medium with the features of claim 10. Further features and details of the invention follow from the respective subclaims, the description, and the drawings. In this context, features and details which are described in connection with the method according to the invention are also applicable in connection with the computer program according to the invention, the apparatus according to the invention, as well as the computer-readable storage medium according to the invention, and vice versa, so that mutual reference is always possible with respect to the disclosure of the invention. Subject matter of the invention is, in particular, a method for generating synthetic images, hereinafter also referred to as image generation or synthesis.

The image synthesis may be provided by means of a generative model, in particular a diffusion model. In other words, the image synthesis may be based on machine learning and/or on a gradual transformation of an initial distribution, in which data is converted into a noisy representation and then iteratively reconstructed. A diffusion model preferably uses a two-phase process: In the forward phase, stochastic noise is added to the data, increasingly blurring the original structure. In the backward phase, noise is gradually removed using a trained neural network to generate the original data or new, synthetic content. This process may be part of a noise regulation process described in more detail below.

Furthermore, the method according to the invention may comprise the following steps, which are preferably performed automatically and/or sequentially and/or repeatedly:
Providing an input,
Processing the provided input in a first iterative process, at least by a noise remover, also referred to as a denoiser, wherein in a first noise regulation process, noise in an intermediate generated image is repeatedly reduced and added,
Processing an intermediate output of the first iterative process in a second iterative process, at least by the and/or a further noise remover, wherein in a second noise regulation process noise is repeatedly reduced and added in multiple intermediate generated images,
Providing an output of the second iterative process, preferably in the form of the generated synthetic images.

The present invention describes a more efficient way to generate images —preferably using a diffusion model. In particular, the invention provides an improved diffusion process which, in the first steps, follows the process for a single data point and only branches off from it at a later stage in order to generate multiple images.

It may be optionally possible that, in respective process steps of the first iterative process, the noise regulation process is performed once on the one intermediate image generated, whereas, in respective process steps of the second iterative process, the noise regulation process is performed multiple times on the multiple intermediate images generated. In other words, the noise regulation process of the first iterative process may also be performed repeatedly, but only once on an intermediate image, meaning that noise is only generated once per noise regulation process. In contrast, in the second iterative process, noise may be generated multiple times per process step, and accordingly, multiple intermediate images are provided per process step (in contrast to the first iterative process). In general, the quality of the images may be improved because the repeated addition and removal of noise in the individual images achieves a higher level of detail. The multiple application of the noise regulation process in the second iterative process also allows for finer adjustment of the images to the text description. This allows detailed structures and patterns to be better represented in the generated images, resulting in a more realistic result.

According to an advantageous further development of the invention, it may be provided that the input comprises at least one of the following:
A text input that describes the image to be generated in terms of content, which preferably defines a goal for the image generation, that a plurality of images are generated that correspond to the text input in terms of content, preferably adapted to a technical application purpose of a machine learning system that is to be trained by the generated images,
A random input, which was preferably generated by means of a random generator, to provide initial noise information.

In other words, the input may comprise both structured content (text description) as well as unstructured content (random input). The text description allows the model to generate images that correspond to a specific content. The random number generation provides an initial noise information that the model may use for the image generation.

Advantageously, it may be provided in the invention that the input comprises at least one initial noise information, wherein the initial noise information is specific to an initially noisy image and, in particular, to a random noise. Here, the first iterative process may perform the noise regulation process starting from the initially noisy image to obtain the intermediate generated image. This achieves the advantage of making the image generation more efficient. The use of initial noise information allows a more direct entry into the denoising process and reduces the number of iterations required. This saves resources and shortens the generation time.

Preferably, within the scope of the invention, it may be provided that in the process steps of the first iterative process, respectively, noise is removed from the one intermediate generated image and then noise is added back to the one intermediate generated image, preferably without using/generating further intermediate generated images and/or further noise per process step.

Furthermore, it may be provided that (first) after the process steps of the first iterative process, noise is generated multiple times in order to thereby add noise to the one intermediate image generated multiple times and, in this way, generate a noisy image respectively, thus multiple noisy images, as the intermediate output of the first iterative process.

Furthermore, it is possible that in the process steps of the second iterative process, the multiple intermediate images generated are generated from the noisy images, and noise is repeatedly reduced and added multiple times in the intermediate images generated. In contrast to the first iterative process, in which noise is only reduced and added once per process step, noise may thus be reduced and added multiple times in the second iterative process. In other words, the denoiser may be used in the first iterative process to generate one noisy image per process step before multiple noisy images per process step are generated and processed in the second iterative process. This can increase the efficiency of the entire process and save resources.

The images that are processed within the processes may also be referred to as intermediate images generated to make it clear that they are internal processing results or intermediate products, e.g., of a diffusion model (i.e., not necessarily a real image output). The output provided by the second iterative process, and thus in particular the final image generated, however, can preferably also be output. Furthermore, the intermediate images generated, the initial input, and the output may also correspond to an abstract representation of an image (e.g., encoded image) or another type of (abstract) signal (e.g., (encoded) audio, video).

It is also conceivable that the at least one noise remover, in particular denoiser, is implemented as an artificial neural network of the generative model, preferably diffusion model, which, for the reduction of the noise, gradually removes the noise from the corresponding image, while the generative model iteratively performs a transition from an initially highly noisy image to a clear, detailed image. This has the advantage that the denoiser may achieve high quality of the generated images due to its iterative structure and gradual noise reduction.

It may be provided within the scope of the invention that the output provided, and in particular the synthetic images, are used as training and/or validation and/or test data for a machine learning system for a use in a technical system, preferably a vehicle and/or robot. This enables, in particular, the machine learning system to be trained to perform a classification and, preferably, object detection on a pixel basis, preferably, to control the technical system based on a classification result. Preferably, the scene may be implemented as a traffic scene and/or as a scene in an industrial plant of the robot. Thus, the generated images may be used to improve machine learning systems. The use of synthetic images as training data allows for efficient training of classification systems, especially for applications in the field of vehicles and robots. This leads to improved pixel-based object recognition and may be used in scenes such as traffic situations or industrial plants to control the technical system.

It is possible that the method according to the invention and/or the machine learning system may be used in a vehicle. The vehicle may, for example, be designed as a motor vehicle and/or passenger car and/or at least partially automated/autonomous vehicle. The vehicle may comprise a vehicle device, for example, for providing an autonomous driving function and/or a driver assistance system. The vehicle device may be designed to control and/or accelerate and/or brake and/or steer the vehicle at least partially automatically.

The method according to the invention may be used to enrich a database with the synthetic images in order to subsequently use the database as a training data set. The machine learning system, in particular in the form of a machine learning model, is trained using the synthetic, i.e., generated, images, in particular for classification and in particular for object detection. Here, the training may be provided to train the machine learning system or the machine learning model using the training data set for classification, in particular for image classification, of image data such as digital images based on image points and/or pixels, in particular pixel values, preferably edges or pixel attributes (of the image data). The image data or digital images may result, for example, from a recording by at least one sensor, preferably at least one camera, preferably of a vehicle, and particularly preferably a camera and/or vehicle environment during a journey (of a vehicle). The recording is possible, for example, by at least one camera of the vehicle. Here, the classification may be intended to recognize objects in an environment depicted by the image data or digital images and/or to capture a traffic scene.

The classification may be intended for various technical applications. One example is application in a vehicle and/or in a robot. Based on the classification, in particular at least one classification result, for example, at least one control action, preferably for a vehicle, the robot, or for another technical system, may be initiated and/or performed.

A classification result may comprise at least one of the following results and/or be specific to at least one of the following results: a category of objects, an identification of objects, a position of objects and/or obstacles (e.g., in the direction of travel or next to the direction of travel), a presence of obstacles, a description of a traffic scene, a hazard warning, a number of objects, a type and/or position of lane markings and/or a lane boundary, a position and/or condition of traffic signal systems, a position of a lane, or the like.

Based on the classification result, at least one control action for the vehicle may be initiated and/or performed. The control action may comprise at least one of the following: a braking, a steering, an acceleration, an overtaking maneuver, an emergency braking, an activation of an alarm system, an activation of a hazard warning light, an activation of a turn signal, a light control, or the like.

The classification may be used, for example, to detect an obstacle, regardless of whether it is directly in the direction of travel or to the side. Depending on the localization (e.g., depending on the expected vehicle trajectory), a corresponding control action such as braking or swerving may be initiated.

Furthermore, for example, braking may be initiated if the classification determines that there are obstacles in the direction of travel and/or a collision is likely. It is also conceivable that a roadway and/or a roadway boundary may be detected on the basis of the classification in order to move the vehicle at least partially automatically on the roadway by the control action.

The “classification” and “image classification” may also comprise “object detection” or “object detection in images.” This refers in particular to a classification of whether or not objects are present in certain areas of the image. In addition, the terms “classification” and “image classification” may also refer to “semantic segmentation,” in particular in the form of pixel-by-pixel classification.

Accordingly, the training may result in at least one trained machine learning model that may be used for the classification and/or object detection. The use and thus the inference may be provided for in a vehicle, for example. The data points of the input data may be pixels of image data, for example, or be based on these in order to perform the classification and/or object detection of the data points on the basis of the pixels. The input data may comprise sensor and/or image data which result at least in part from a capturing of a sensor, preferably camera sensor, and/or which have been at least partially synthesized, i.e., in particular, which replicate the real data of a sensor. Specifically, it may be provided that the values of image points, preferably pixels, of the image data represent an environment of a sensor and/or a vehicle and/or a traffic scene. Classification, preferably image classification and/or object detection, may be provided on the basis of these values. This allows, for example, to detect objects in the traffic scene. The image data may be, for example, images from a radar sensor and/or an ultrasonic sensor and/or a LIDAR sensor and/or a thermal imaging camera. Accordingly, the images may also be radar images and/or ultrasonic images and/or thermal images and/or LiDAR images.

The invention also relates to a computer program, in particular a computer program product, comprising instructions which, when the computer program is executed by at least one computer, cause it to carry out the method according to the invention. The computer program according to the invention thus offers the same advantages as those described in detail with reference to a method according to the invention.

The invention also relates to a data processing apparatus which is configured to carry out the method according to the invention. At least one computer that executes the computer program according to the invention may be provided as the apparatus. The computer may comprise at least one processor for executing the computer program. A non-volatile data memory may also be provided, in which the computer program may be stored and from which the computer program may be read by the processor for execution.

The invention may also relate to a computer-readable storage medium which comprises the computer program according to the invention and/or instructions which, when executed by at least one computer, cause it to carry out the method according to the invention. The storage medium is designed, for example, as a data memory such as a hard disk and/or a non-volatile memory and/or a memory card. The storage medium may, for example, be integrated into the computer.

In addition, the method according to the invention may also be implemented as a computer-implemented method. Alternatively or additionally, at least one of the disclosed method steps may be computer-implemented and/or performed automatically.

### BRIEF DESCRIPTION OF THE DRAWINGS

Further advantages, features, and details of the invention are apparent from the following description, in which embodiments of the invention are described in detail with reference to the drawings. Here, the features mentioned in the claims and in the description may be essential to the invention individually or in any combination. Shown are:

FIG. 1 a schematic visualization of a method, an apparatus, a storage medium, and a computer program according to embodiments of the invention.

FIG. 2 another schematic representation of embodiments of the invention.

### DETAILED DESCRIPTION

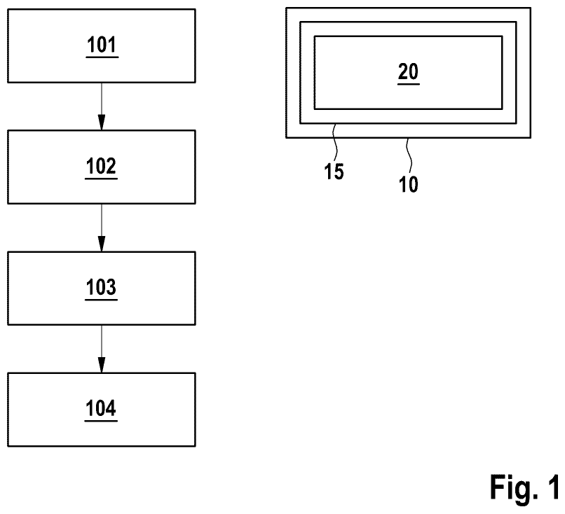

In FIG. 1, a method 100, a device 10, a storage medium 15, and a computer program 20 according to embodiments of the invention are shown schematically. Furthermore, FIG. 1 illustrates, according to embodiments of the invention, an application of the method 100 for generating synthetic images by means of a generative model, in particular a diffusion model.

In a method step 101, for this purpose, an input is provided, which may comprise, for example, a text input and a random input.

Then, in a second method step 102, a processing of the provided input may take place in a first iterative process. At least one noise remover, also referred to as denoiser, may be used for this purpose. In a first noise regulation process, noise in an intermediate generated image is repeatedly reduced and added.

Then, in a third method step 103, a processing of an intermediate output of the first iterative process in a second iterative process may be provided. Here, too, at least the denoiser or another denoiser may be used. Here, in a second noise regulation process, noise is repeatedly reduced and added in multiple intermediate images.

Finally, according to a fourth method step 104, a provision of an output of the second iterative process is provided.

One of the most common model classes used today to generate image data for use as training data are diffusion models, see, for example, “Ho, Jonathan, Ajay Jain, and Pieter Abbeel. ‘Denoising diffusion probabilistic models.’ Advances in neural information processing systems 33 (2020): 6840-6851”. These models have the property that they may reverse a given diffusion process.

For example, the diffusion process is formulated as follows:
1. Input: A data point (e.g., in an image)
2. Repeat N times: Add noise (often based on normal distribution) of a certain strength to the data point. The strength may vary at each step.
3. Output: A new data point that should be indistinguishable from noise when N is high.

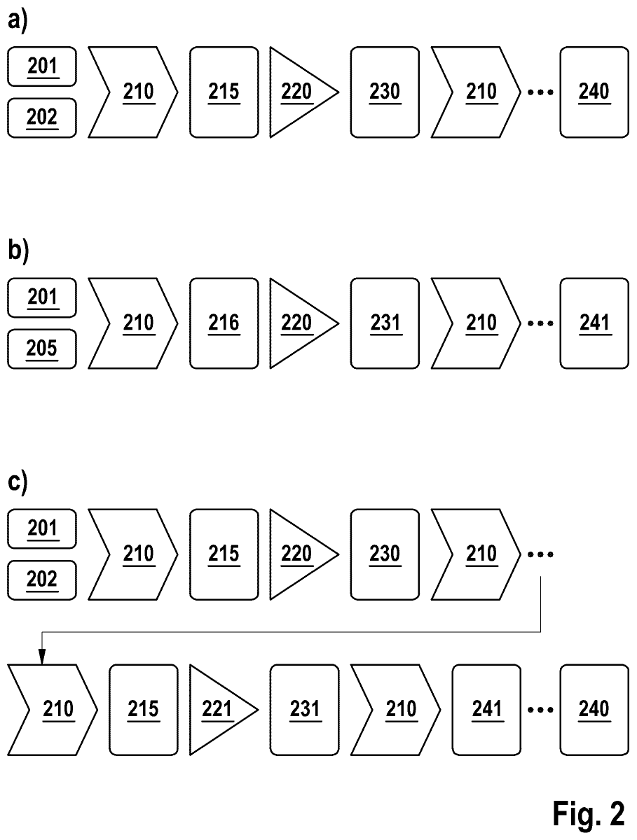

A diffusion model learns the inverse process based on this process. Given a data point in step t, it may therefore estimate the noise that was added from t−1 to t. According to the literature, an inverse process may be formulated as follows see a) in FIG. 2:
1. Input: a data point consisting only of noise.
2. Repeat N times: Estimate the noise using the diffusion model and subtract the noise from the data point. Then add noise again (depending on the current step t).
3. Output: A new data point that should be similar to the data points used to train the diffusion model.

This process may be very time-consuming, depending on the number of steps N.

In practice, one often wants to generate multiple data points based on the same input. The typical approach for this is to generate multiple points in parallel. So one starts with a list of B data points instead of just one data point—see b) in FIG. 2.

On the other hand, there is evidence that at the beginning of the inverse process, often similar noise is estimated. Estimating for each of the B data points is therefore unnecessary.

Therefore, embodiments of the invention present an improved diffusion process that follows the process for a single data point in the first steps and only branches off from it at a later stage to generate multiple images (see also FIG. 2).

The later branching makes the process more efficient than previous diffusion processes.

Variants of the invention include the following aspects—see also c) in FIG. 2:

According to a first aspect, a denoiser (for example, a neural network of the U-Net family) receives a text input and an input generated by a random generator. The goal is to output B images that correspond to the text input. It is started at step T.

According to a second aspect, the denoiser follows a process consisting of T steps, wherein the denoiser removes noise from the image at each step, and then adds noise back to the image.

According to a third aspect, after n steps following the removal of the noise by the denoiser, B times noise is generated in order to add B times noise to the image.

According to a fourth aspect, in the steps from n to 0, each of the B images is denoised separately and mixed with noise again.

According to a fifth aspect, the output is B images that correspond to the text input, wherein the first n steps are as efficient as if only one image had been generated.

The denoiser (also referred to as a noise remover) is thus able to generate at least one image based on at least one text input and a random input vector.

In FIG. 2, a) shows the regular denoising process, b) shows the procedure for multiple images according to the regular process, and c) shows the modified process according to embodiments of the invention. Here, a prompt 201 and random noise 202 or a stack of random noise values 205 are used as input. The input data is fed to a denoiser 210 to obtain a denoised image 215 or a stack of denoised images 216. Noise 220 or B times noise 221 may then be added. This may result in a noisy image 230 or a stack of noisy images 231. By applying the denoiser 210, a denoised image 240 or a stack of denoised images 241 may be obtained.

The foregoing description of the embodiments describes the present invention exclusively in the context of examples. Of course, individual features of the embodiments may be freely combined with each other, provided that this is technically sensible, without departing from the scope of the present invention.

1. A method for generating synthetic images by means of a generative model, the method comprising the following steps:
Providing an input,
Processing the provided input in a first iterative process, at least by a noise remover, wherein in a first noise regulation process, noise in an intermediate generated image is repeatedly reduced and added,
Processing an intermediate output of the first iterative process in a second iterative process, at least by the and/or a further noise remover, wherein in a second noise regulation process noise is repeatedly reduced and added in multiple intermediate generated images,
Providing an output of the second iterative process.

2. The method according to claim 1, characterized in that, in respective process steps of the first iterative process, the noise regulation process is performed once on the one intermediate image generated, whereas, in respective process steps of the second iterative process, the noise regulation process is performed multiple times on the multiple intermediate images generated.

3. The method according to claim 1,
characterized in that the input comprises at least one of the following:
A text input that describes the image to be generated in terms of content, that a plurality of images are generated that correspond to the text input in terms of the content,
A random input, generator, to provide initial noise information.

4. The method according to claim 1,
characterized in that the input comprises at least one initial noise information, wherein the initial noise information is specific to an initially noisy image and, wherein the first iterative process performs the noise regulation operation starting from the initially noisy image to obtain the intermediate generated image.

5. The method according to claim 1,
characterized in that in the process steps of the first iterative process, respectively, noise is removed from the one intermediate generated image and then noise is added back to the one intermediate generated image, and
after the process steps of the first iterative process, noise is generated multiple times in order to thereby add noise to the one intermediate image generated multiple times, and, in this way, generate a noisy image respectively, thus multiple noisy images, as the intermediate output of the first iterative process, and
in the process steps of the second iterative process, the multiple intermediate images generated are generated from the noisy images, and noise is repeatedly reduced and added multiple times in the intermediate images generated.

6. The method according to claim 1,
characterized in that the at least one noise remover, is implemented as an artificial neural network of the generative model, which, for the reduction of the noise, gradually removes the noise from the corresponding image, while the generative model iteratively performs a transition from an initially highly noisy image to a clear, detailed image.

7. The method according to claim 1,
characterized in that the synthetic images are used as training and/or validation and/or test data for a machine learning system for a use in a technical system, to train the machine learning system to perform a classification.

8. (canceled)

9. Data processing apparatus comprising:
one or more processors;
a non-transitory computer-readable storage medium comprising instructions, which when executed by at least one computer, cause the computer to:
Provide an input,
Process the provided input in a first iterative process, at least by a noise remover, wherein in a first noise regulation process, noise in an intermediate generated image is repeatedly reduced and added,
Process an intermediate output of the first iterative process in a second iterative process, at least by the and/or a further noise remover, wherein in a second noise regulation process noise is repeatedly reduced and added in multiple intermediate generated images, and
Provide an output of the second iterative process.

10. Computer-readable storage medium, comprising instructions which, when executed by at least one computer, cause the computer to:
Provide an input,
Process the provided input in a first iterative process, at least by a noise remover, wherein in a first noise regulation process, noise in an intermediate generated image is repeatedly reduced and added,
Process an intermediate output of the first iterative process in a second iterative process, at least by the and/or a further noise remover, wherein in a second noise regulation process noise is repeatedly reduced and added in multiple intermediate generated images, and
Provide an output of the second iterative process.

11. The method of claim 3 wherein at least one of:
(a) the text input defines a goal for the image generation; or
(b) the random input is generated by a random generator.

12. The method of claim 4 wherein the initial noise information comprises a random noise.

13. The method of claim 6 wherein at least one of:
(a) the generative model is a diffusion model; or
(b) the at least one noise remover comprises a denoiser.

14. The method of claim 7 wherein at least one of:
(c) the technical system is a vehicle and/or a robot;
(d) the machine learning system is trained to perform object detection on a pixel basis;
(e) the machine learning system is trained to control the technical system on the basis of a classification result; or
(f) a scene of the synthetic images is implemented as a traffic scene and/or as a scene in an industrial plant of the robot.
